(19) United States
(12) Patent Application Publication
(10) Pub. No.: US 2008/0163977 A1
(43) Pub. Date: Jul. 10, 2008

(54) Process For the Production of Film Laminates For Composite Glazing of Partial Films of Different Compositions

(76) Inventor: Uwe Keller, Bonn (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/573,845

(22) PCT Filed: Aug. 11, 2005
(86) PCT No.: PCT/EP2005/053955

§ 371 Date: Sep. 25, 2007

(30) Foreign Application Priority Data
Aug. 17, 2004 (DE) 10 2004 000 023.9

(51) Int. Cl. B29C 65/02

(52) U.S. Cl. 156/285; 156/60

(57) ABSTRACT

The invention relates to the production of intermediate layer films for composite glazings by the combination of partial films containing softener to form an intermediate layer film, softener parts migrating between the partial films. The invention also relates to the production of composite glazings using said intermediate layer films.

### TECHNICAL FIELD

The present invention relates to the production of intermediate layer films for composite glazing by combining plasticizer-containing partial films to form an intermediate layer film with migration of plasticiser portions between the partial films, and to the production of composite glazing with these intermediate layer films.

When considering the properties of typical intermediate layer films for composite safety glass it is found that these are similar with respect to mechanical and chemical properties which can be measured on the film itself and with respect to the mechanical properties which can be determined on the composite glass made therefrom. For example, the products exhibit similar tear strengths and elongations at break and Shore A hardnesses. The reason for this is that the different manufacturers optimise their products with respect to the required safety properties of the composite glass, the processability of the film during the manufacture of the composite glass, the manufacture of the film in the extrusion process as well as the costs and availability of the raw materials, leading to relatively similar products. As the term composite safety glass expresses, the actual task of the intermediate layer film consists of making glass safer as a transparent material, for example by reducing the risk of injury on glass breakage.

Recently, interest in further optimisation of composite glass towards improved sound deadening and/or improved protection against burglary has grown since it has been recognised that, in spite of the largely constant material properties of float glass, the properties of the composite, such as behaviour under vibration or breakage behaviour, can be improved by modifying the film intermediate layer by using special films based on polyvinyl butyral (PVB).

### STATE OF THE ART

It is, for example, known from EP 0 118 12 58 B1 that a certain increase in the Plasticiser content of a PVB film and/or an operating layer causes improved sound deadening in the composite glass since the maximum of the loss factor for vibrations of acoustic frequencies is displaced from relatively high temperatures towards lower temperatures and consequently to the vicinity of room temperature. Since this is accompanied by a decrease in the glass transition and film softening temperature, an increased Plasticiser content usually also causes a weakening of the mechanical strength of the film. However, this can go so far that problem-free unwinding from a storage roll—in particular under tensile stress—and alignment of the film on the bottom class Pane and/or in combination with further film layers is no longer guaranteed. Moreover, PVB films with a high Plasticiser content are difficult to process because of their tackiness.

On the other hand, there is growing interest in more rigid PVB films and/or operating layers in order to obtain products of higher performance with an increased penetration resistance either as such or in combination with further intermediate layers. Films of this type have been described in WO 03/097347 A1 and WO 01/43963 A1 and usually contain less plasticiser than a standard PVB film.

Such materials and/or operating layers which differ in their Plasticiser content and consequently their strength from established standard films may exhibit the disadvantage of not being laminateable under the same conditions as a standard film. A film with a low Plasticiser content is, as a rule, more difficult to laminate to form composite glass since the flowability of the material is substantially reduced at elevated temperatures in comparison with a standard PVB film for which reason flowing and problem-free melt fusion of the film surface to a level glass surface, as a precondition for complete transparency, is made more difficult. In addition, cutting hard films is made considerably more difficult both for the film manufacturers and the processor of the films to form composite glazing such that special cutting tools have to be used.

In order to avoid these problems, products have been developed, for example, in the case of which a PVB layer with a high Plasticiser content is embedded between two layers of standard PVB. Films of this type are made by a coextrusion process since the intermediate layer with a high Plasticiser content would be far too weak mechanically speaking on its own and, moreover, too tacky for laminating the corresponding individual films.

Thus, JP 2004-99354 discloses the production of a multi-layer film by coextruding two PVB mixtures with different Plasticiser contents. Apart from the Plasticiser content, the PVB resins used differ from each other regarding their polarity as a result of different residual acetate fractions and degrees of acetalisation. The migration of the plasticiser between the coextrusion layers results in hard and soft film layers which are capable of forming an acoustically effective film composite e.g. in the “hard-soft-hard” sequence. Coextrusion of multi-layer films is a complex and time-consuming process since the layer thicknesses need to be precisely maintained.

PVB films consisting of several layers of different composition are known from EP 1 218 690 A1. In this case, vibration attenuation and consequently the sound insulation behaviour of PVB films are to be balanced by several films with different Plasticiser content being combined. For the different Plasticiser contents of the layers and consequently the intended effect to remain constant, no migration of the plasticiser may take place in the case of the film laminates according to EP 1 218 690 A1. A disadvantage is also in this case that processing of PVB films with a high or low Plasticiser content is difficult.

The combination of a PVB film with a polyurethane film according to WO 03/006240 entails the risk of a plasticiser migration and consequently exudation of the plasticiser and even delamination of the films from the glass.

The manufacture of intermediate layer films by combining PVB partial films is known from WO 03/097347 A1, EP 0566890 B1 and EP 0508864 B1. In this case, partial films of identical PVB polymers with different plasticisers are combined (WO 03/097347 A1, EP 0508864 B1) and/or PVB polymers with a very high residual acetate content are used (EP 0566890 B1).

### OBJECT

The migration of the plasticiser between the partial films is not described in this publication. The migration of plasticiser is usually also not desirable since, as a result of migration of the plasticiser, turbidity, blister formation, delamination or exudation may occur in the composite glass.

Surprisingly enough, it has been found that partial films of different composition can be laminated to each other in such a way that a film laminate with layers of different mechanical and/or acoustic properties results from the migration of the plasticiser contained in the partial films.

In this way, the processing disadvantages of very hard or very soft individual films are avoided since the modified properties arise only as a result of the migration of plasticiser in the finished film laminate.

### PRESENTATION OF THE INVENTION

The subject matter of the present invention is consequently a process for producing film laminates by lamination of at least two partial films, at least one partial film containing at least one plasticiser with a first Plasticiser content, migration of at least one plasticiser between the partial films with adjustment of a second Plasticiser content, the first and the second Plasticiser contents of at least one partial film differing by at least 0.5% by weight and the partial films being based on different polymers.

Preferably, partial films containing entirely or partially acetalised polyvinyl alcohol with different polyvinyl alcohol contents and/or residual acetate contents are laminated to each other.

The partial films used according to the invention are based on different polymers, in particular on the following polymers: entirely or partially acetalised polyvinyl alcohol, PVB, polyvinyl chloride, ethylene-vinyl acetate copolymer, ethylene-vinyl alcohol copolymer and/or entirely or partially acetalised ethylene-vinyl alcohol copolymer.

To these polymers, the usual additives such as plasticisers, UV stabilisers, surfactants, antioxidants and adhesion regulators are added and processed to form films.

The proportion of plasticiser in the partial films used according to the invention relates to the proportion by weight of a plasticiser and is calculated with respect to the finished recipe of plasticiser and polymeric material and additives. If a partial film contains several plasticiser components as a mixture the difference between the first and the second proportion of plasticiser (i.e. before and after lamination) is based on each individual component of the mixture. The partial films may contain the same or a different plasticiser with the same or a different first proportion of plasticiser.

The use according to the invention of different polymers comprises chemically different polymers such as e.g. PVB and acetalised ethylene-vinyl alcohol copolymer as well as chemically similar polymers, e.g. PVB with different molecular weights. Polyvinyl alcohols or ethylene-vinyl alcohol copolymer and its acetalised derivatives, in particular polyvinyl butyrals with different polyvinyl alcohol contents, degrees of acetalisation, residual acetate content, proportion of ethylene, molecular weight and/or different chain lengths of the aldehyde of the acetal groups are such different polymers.

Preferably, one or several aliphatic aldehydes with 2 to 10 carbon atoms, in particular butyraldehyd, are used for the acetalisation of the polyvinyl alcohols or the ethylene-vinyl alcohol copolymer.

The partial films may contain also mixtures of plasticisers with both different and/or the same compositions. Different composition means both the type of plasticiser and its proportion in the mixture.

Mixtures used according to the invention contain 15-50% by weight, preferably 20-40% by weight and in particular 25-30% by weight of plasticiser. If acetalised polyvinyl alcohols and/or ethylene-vinyl alcohol copolymers, in particular polyvinyl butyral, are used as polymers they exhibit preferably a residual acetate content of 0 to 3.5 mole %, in particular 0.1 to 3.5% or 0-2 mole % or 0.1-2 mole % and/or a proportion of polyvinyl alcohol (PVOH) of 15-25% by weight, in particular 17-23% by weight. Preferably, plasticiser-containing PVB films containing mixtures according to DE 101 62 338 A1 or WO 02/102591 A1 are used as partial film.

The partial films used according to the invention may contain different plasticisers, plasticiser mixtures and/or proportions of plasticiser. Suitable plasticisers are one or several compounds selected from the following group:
Esters of multivalent aliphatic or aromatic acids, e.g. dialkyl adipates such as dihexyl adipate, dioctyl adipate, hexyl cyclohexyl adipate, mixtures of heptyl and nonyl adipates, diisononyl adipate, heptylnonyl adipate as well as esters of adipic acid with cycloaliphatic or ester bonds-containing ester alcohols, dialkyl sebacates such as dibutyl sebacate as well as esters of sebacic acid with cycloaliphatic or ether bonds-containing ester alcohols, esters of phthalic acid such as butyl benzyl phthalate or bis-2-butoxyethyl phthalate
Esters or ethers of multivalent aliphatic or aromatic alcohols or oligoether glycols with one or several unbranched or branched aliphatic or aromatic substituents such as e.g. esters of diglycols, triglycols or tetraglycols with linear or branched aliphatic or cycloaliphatic carboxylic acids; as an example of the latter group, diethylene glycol bis-(2-ethyl hexanoate), triethylene glycol bis-(2-ethyl hexanoate), triethylene glycol bis-(2-ethyl butanoate), tetra ethylene glycolbis-n-heptanoate, triethylene glycol bis-n-hexanoate, tetraethylene glycol dimethyl ether and/or dipropylene glycol benzoate can be used
Phosphates with aliphatic or aromatic ester alcohols such as e.g. tris (2-ethyl hexyl) phosphate (TOF), triethyl phosphate, diphenyl-2-ethyl hexyl phosphate and/or tricresyl phosphate
Esters of citric acid, succinic acid and/or fumaric acid.

Particularly preferably di-n-hexyl adipate (DHA), triethylene glycol-bis-n-heptanoate (3G7), tretaethylene glycol bis-n-heptanoate and/or triethylene glycol bis-2-ethyl hexanoate (3GO or 3G8) are used as plasticiser.

The intermediate films disclosed e.g. in EP 1 181 258 B1 which are based on plasticiser-containing, partially acetalised polyvinyl alcohol, in particular PVB, can be used as partial film for the manufacture of composite glazing with a reduced permeability to sound. In this case, a polyalkylene glycol with the formula HO—(R—Of)n-H or derivatives derived therefrom are used for the manufacture of sound deadening PVB films in addition to at least one of the above-mentioned standard plasticisers. With respect to the type, quantity and composition of the plasticiser mixtures, the disclosure of EP 1 181 258 B1 is fully taken into account. Preferably, the sum total of plasticising components, i.e. standard plasticiser and/or polyalkylene glycol as such or as mixture, represents 20-50% by weight of the partial film concerned. In a preferred embodiment of the invention, the total Plasticiser content amounts to 25 to 40% by weight, particularly preferably 30 to 35% by weight. The proportion of polyalkylene glycol in the partial film preferably amounts to more than 5% by weight, particularly preferably more than 10% by weight, based on the total film recipe in each case.

It is also possible to use in the process according to the invention partial films which contain a multi-component plasticiser mixture. It corresponds also to the meaning of the invention that one of several individual components in a mixture used for plasticising migrates preferably in the case of the desired plasticiser migration. If, for example, a partial film A originally contains only the plasticiser component 1 and a partial film B originally contains only plasticiser component 2, the change in concentration may be greater in the case of component 1 than in the case of component 2.

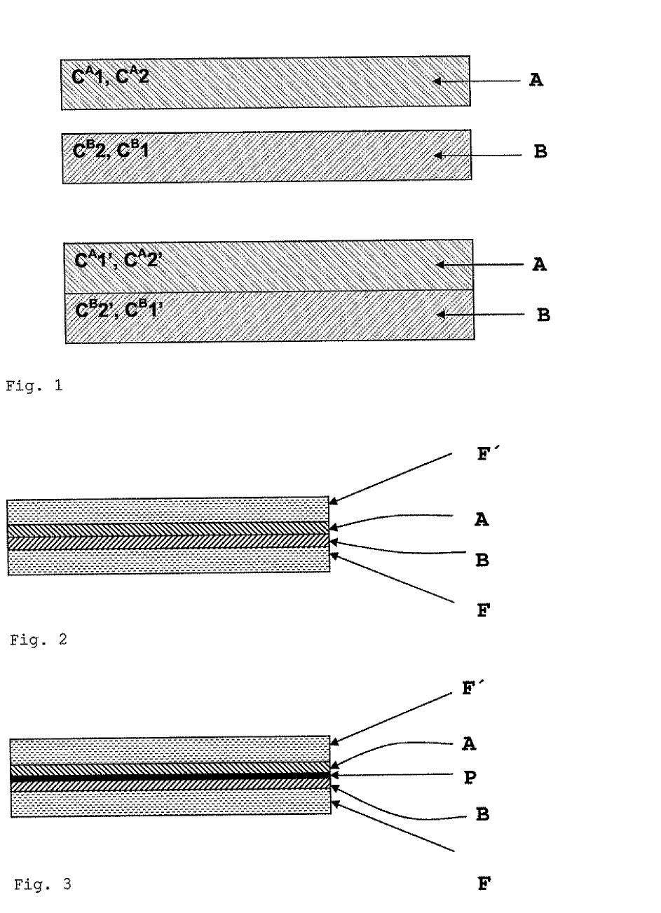

FIG. 1 shows the Plasticiser content of partial films A and B before and after lamination, i.e. with the first and second proportion of plasticiser.

Following lamination, a shift in the plasticiser components takes place between one or several partial films A containing originally one or several plasticiser components 1, 2, . . . m in the concentrations C^{A}1, C^{A}2, . . . C^{A}m and one or several partial films B containing originally one or several plasticiser components 1, 2 . . . n in the concentrations C^{B}1, C^{B}2, . . . C^{B}m, as a result of which the concentrations of C^{A}1, C^{A}1′, C^{A}2′, . . . C^{A}m′ and C^{B}1′, C^{B}2′, . . . C^{B}m′ are obtained and the amount of the change in concentration of at least one of the components C^{A}n′-C^{A}n, or C^{B}n-C^{B}n is more than 0.5% by weight.

Basically, the difference between the first and second Plasticiser content is limited only by the absorption and/or discharge capacity of the film concerned. In particular embodiments of the invention, the first and second Plasticiser content of at least one plasticiser component of at least one partial film differs by more than 1,2,3,4,5,6,7,8,9 or 10% by weight. The maximum difference in the Plasticiser content may be below 50, 25, 15, 11, 10 or 5% by weight.

In addition to the Plasticiser content, the water content of the partial films is of interest. Thus, a high water content of a polar PVB film, for example, leads to an increased absorption of polar plasticizer, whereas non-polar plasticiser is driven out from such a film. In the former case, the film becomes softer, in the second case harder. This synergistic behaviour can, for example, be chosen in order to make an individual film with as low a content of non-polar plasticiser as possible from the process technology point of view and a high water content even harder by the loss of plasticiser in the film laminate brought about forcibly by the different polarities.

Since water, too, migrates between the partial films in the laminate, this effect depends on the first (before lamination) or the second (after lamination) water content of at least one partial film.

In a particular variation of the invention, the first and second water content of at least one partial film changes by at least 5% by weight, preferably by at least 5 to maximum 50% by weight, particularly preferably by up to maximum 10 or 25% by weight. This change needs to be calculated relative to the first (initial) content of at least one partial film.

In order to be able to adjust the Plasticiser content which is decisive for the mechanical properties in partial films, which are in contact with each other, differently on a permanent basis and to avoid levelling of the plasticiser concentration, the affinity to the plasticiser in the partial films should be of different strength.

This may be the case if the polymeric base of the partial films differs. In the case of partially acetalised polyvinyl alcohols such as PVB, this can be regulated by way of the residual polyvinyl alcohol (PVOH) content, among others, and consequently via a polarity of the PVB resin, resins with a higher PVOH content having a higher polarity with an otherwise comparable constitution. Thus, a plasticiser of a low polarity will preferably remain in an environment which is also less polar. If two PVB films which differ from each other with respect to the PVOH content of the PVB resin used for their production but contain the same non-polar plasticiser in initially identical concentration, are brought into direct contact, a difference in concentration will soon develop because the plasticiser migrates from the film with the higher PVOH content into the film with the lower PVOH content.

It is consequently part of the invention to laminate partial films which exhibit PVB with a different polyvinyl alcohol content to each other. These films in turn may contain the same or a different first proportion of plasticiser.

If the partial films differ with respect to their polymer base, it may be advantageous to formulate the original partial films with a first Plasticiser content with those plasticisers which exhibit a particularly high or a particularly low affinity to one of the two polymeric bases. For example, it is known from EP 1 181 258 B1 that PVB of high polarity with a high PVOH content exhibits a higher affinity to and/or compatibility with those plasticisers which are also “polar”. A helpful measure for classifying solvents and/or plasticisers on a polarity scale in the widest sense is provided by the Small solubility parameter δ, the plasticiser with an affinity to polar polymers exhibiting higher and the plasticiser with an affinity to non-polar polymers lower δ-values. Those plasticisers have proved to be plasticisers of low polarity with respect to acetalised polyvinyl alcohols which exhibit a solubility parameter δ at 25° C. of less than 8.6 (cal/cm³)^{1/2} or 17.59 (J/cm³)^{1/2}. For simplicity's sake, δ can be determined by means of the so-called Small constants as listed in table form under “Solvents and plasticisers” (vol. 1, edition 8, page 593, Gnamm/Fuchs, Wissenschaftliche Verlagsgesellschaft mbH Stuttgart 1980). For example, triethylene glycol-di-n-heptanoate has a δ of 8.71 (cal/cm³)^{1/2}, triethylene glycol-di-2-ethyl hexanoate a δ of 8.51 (cal/cm³)^{1/2} and dipropylene glycol dibenzoate (e.g. Benzoflex® 9-88), as an example of a particularly polar plasticiser, a δ of 9.83 (cal/cm³)^{1/2}. These values apply to mixtures with acetalised polyvinyl alcohols, butyraldehyde, formaldehyde, acetaldehyde or propanal being preferably used for acetalisation.

In order to produce a particularly hard partial film based on partially acetalised polyvinyl alcohol in the film laminate, this can be produced from a resin with a high PVOH content and a plasticiser with a good compatibility therewith and combined with a further partial film which contains a plasticiser of medium polarity. Since the plasticiser of medium polarity has only a slight tendency to migrate in the direction of the first partial film, the plasticiser of high polarity is, however, compatible also with the resin of the second partial film, the partial film with the high PVOH content overall will give off more polar plasticiser than that of the non-polar type is capable of absorbing. This then results in a partial film which is particularly hard in the composite and provides the total composite with a high mechanical stability.

In a preferred variation of the process according to the invention, at least one partial film is based on acetalised polyvinyl alcohol, preferably PVB, and the film laminate contains at least two plasticisers whose solubility parameters δ differ by at least 0.01 (cal/cm³)^{1/2}, preferably by 0.05 (cal/cm³)^{1/2}, in particular by 0.1 (cal/cm³)^{1/2}. The solubility parameters δ of the plasticiser should not differ by more than 5 (cal/cm³)^{1/2}. The plasticisers may be contained in one or several partial films, the thermodynamic concentration equilibrium being adjusted on the basis of the different solubility parameters δ. The partial films may both be based on acetalised polyvinyl alcohol, preferably PVB. As an alternative, at least one partial film may be based on acetalised polyvinyl alcohol, preferably PVB and at least one other partial film on the so-called polymers.

In an analogous manner it is possible to assess the “polarity” of acetalised polyvinyl alcohols of different composition, in particular polyvinyl butyral, by calculating a solubility parameter. For this purpose, the incremental values of the solubility parameters δ which belong to the constituents of acetal function (the so-called aldehydes), vinyl alcohol and vinyl acetate can be taken from J. K. Sears, N. W. Touchette, 1989 Plasticisers, page 583 (“Encyclopaedia of Polymer Science and Engineering” 2nd Edition, John Wiley and Sons, New York).

The solubility parameter δ for a polyvinyl acetal is obtained as average value, weighted by the proportion by weight of the constituents, from the incremental values. For a PVB with the composition of 79.0% by weight of butyral, 20.5% by weight of PVOH and 0.5% by weight of PVAc and the values 8.288, 22.910 and 9.558 (cal/cm³)^{1/2} δ PVB is calculated as 9.04 (cal/cm³)^{1/2}. For polyvinyl acetals with constituents modified in comparison with the basic type, analogous calculations can be carried out easily using the values listed in table form in Gnamm/Fuchs.

| BUTYRAL | PVOH | PVAc | δ PVB |
|---|---|---|---|
| 8.288 | 1.910 | 9.558 | |
| % by Weight | % by Weight | % by Weight | |
| 81.2 | 18.3 | 0.5 | 8.96 |
| 79.0 | 20.5 | 0.5 | 9.04 |
| 76.0 | 23.5 | 0.5 | 9.15 |

It is, consequently, possible for the film laminate to contain at least two partial films, based on acetalised polyvinyl alcohol, whose solubility parameters δ differ by at least 0.001 (cal/cm³)^{1/2}, preferably by 0.005 (cal/cm³)^{1/2}, in particular by 0.1 (cal/cm³)^{1/2}. The solubility parameters δ of the partial film should not differ by more than 5 (cal/cm³)^{1/2}.

The change in the plasticiser concentration by migration will begin as early as during the manufacturing process of composite safety glass if film layers of different plasticiser affinity of the polymer matrix are placed on top of each other between two class Panes. The migration process can have progressed considerably after an autoclave step which is common practice in the manufacture of composite glass and terminate on reaching the thermodynamic equilibrium.

The migration of plasticiser in the above-mentioned polymers is temperature and time dependent. In practice, it has proved advantageous to carry out the process according to the invention at a slightly elevated temperature, e.g. by storing the film material for 30 minutes at at least 40° C., preferably 60° C. This can also be carried out on the finished composite glass or on the prelaminate. As a rule, migration is completed after an autoclave or vacuum process which is common practice in the manufacture of composite glass. Preferably, the storage is effected for at least 1,2,3 or 4 hours at minimum 80, 100, 120 or 140° C.

As an alternative, partial films can also be placed or rolled up on top of each other without making a glass composite such that, after storage for at least 24 hours, preferably 48 hours or 96 hours at minimum 20° C., migration is completed. Obviously, an increase in temperature leads to a reduction in the necessary migration period and visa versa.

However, a change in the plasticiser distribution will also arise if the film layers with different plasticiser affinities of the polymer matrix are combined with each other in a coextrusion process. This may be advantageous in order to change the rheology of the mass streams meeting each other in the extrusion tool to a similar level. The distribution equilibrium of the plasticiser and consequently the adjustment of the desired mechanical properties occurs in a time-delayed manner only on discharge from the extrusion die.

Preferably, the process according to the invention is carried out by combining (laminating) partial films which have already been fully manufactured (extruded), i.e. without the coextrusion of the partial films to film laminate. However, it is possible to use partial films produced in turn by coextrusion.

The process according to the invention utilises the diffusion-driven displacement of plasticisers between at least two partial films or operating layers which are in contact with each other as a result of which other plasticiser contents are adjusted during the final state of the thermodynamic equilibrium than in the state before contact is made. The driving force during the formation of a distribution equilibrium capable of leading to a difference in plasticiser concentration between the different operating layers consists of their different affinities to the plasticiser concerned.

Since the position of the distribution equilibrium is not only material dependent but also mass dependent, the process according to the invention also involves the controlled adjustment of the Plasticiser content of a partial film by varying the mass ratio of the film layers brought into contact with each other which can be realised by the thickness variation of the partial films.

In the process according to the invention, the partial films can consequently exhibit the same or a different thickness. As a result, the plasticiser absorption or discharge of the thinner film is brought about forcibly thermodynamically. If, for example, partial film B has a greater thickness than A, the thermodynamic equilibrium of the plasticiser concentration is on the side of film A which consequently absorbs plasticiser and becomes softer. The corresponding depletion of the thicker partial film can be so slight as a result of the higher material weight that its properties, such as hardness or sound deadening, remain almost unchanged.

The thinner partial films used according to the invention can have a thickness of 10%, 25%, 50% or 90% of that of the thickest film of the film laminate.

The films produced according to the invention are preferably used for making composite glazing. A further subject matter of the present invention is consequently also a process for the production of composite systems of at least two rigid bodies and at least one film laminate produced by lamination of at least two partial films, at least one partial film of which contains at least one plasticiser with a first Plasticiser content, migration of at least one plasticiser between the partial films while maintaining a second Plasticiser content, with the proviso that the first and second Plasticiser contents of at least one partial film differ by at least 0.5% by weight and the partial films are based on different polymers, by arranging the partial films between the rigid bodies and applying higher temperatures and an increased or reduced pressure.

Panes of glass, PMMA or PET or polycarbonate can be used in particular as rigid bodies. Preferably, these composite systems consist of at least two class Panes and at least one film laminate produced according to the invention. The film laminate may contain 2,3,4,5 or 6 partial films.

The main production of composite safety glazings is described e.g. in EP 1 85 863 B1, EP 1 118 258 B1 or WO 02/102591 A1. The production of sound insulation glazing based on PVB can be found in EP 387 184 B1.

The thickness of the film laminates produced according to the invention is appropriately adjusted to the thicknesses in international use such as 0.38, 0.51, 0.76, 1.14 and/or 1.52 mm. This means that the partial films may have any suitable thickness between these values, thicknesses of 0.38 mm or a multiple thereof being preferable for technical production reasons.

The conditions to be adjusted during the production of composite systems are known to the expert. Thus, autoclave processes are carried out at an elevated pressure of approximately 10 to 15 bar and elevated temperatures of 130 to 145° C. over a period of approximately 2 hours. Vacuum bag or vacuum ring processes, e.g. in line with EP 1 235 683 B1, operate at a reduced pressure of approximately 200 mbar and a temperature of 130 to 145° C. In the process according to the invention, vacuum laminates can also be used in which the lamination process can be carried out in the course of 30 to 60 min at reduced pressures of 0.01 to 300 mbar and temperatures of 100 to 200° C., in particular 130 to 160° C.

During the production of the film laminates and/or the composite systems, vibration attenuating or penetration inhibiting products can be achieved.

### Vibration Attenuating Composite Glazings

These preferably contain film laminates of at least one soft, i.e. high Plasticiser content, partial film and a partial film which is relatively hard in comparison. Such laminates may provide advantages in particular in the case of a 3 layer “hard/soft/hard” film composite since the mechanically soft and tacky inner film is present in a protected manner between the two in comparison relatively hard layers during the manufacture of the composite system. In this case, it is also possible to use a two layer hard/soft system, the hard layer preferably having a greater thickness.

### Penetration Inhibiting Composite Glazings

For this purpose, hard intermediate layers are usually used. These are frequently difficult to process and/or exhibit an unsatisfactory melt fusion behaviour vis-à-vis glass. In this case, a laminate of the soft/hard/soft film combination is provided, with the “soft” films being able to possess the tackiness and the adhesiveness of a normal, commercially available PVB film. For high-strength glazings, such composites may also consist of 3 or more class Panes which are bonded to each other by film laminates according to the invention.

The properties “hard” and “soft” should be understood to be relative in comparison with the initial state. In the case of a film laminate of a thick and of a thin partial film, the thin film may e.g. become “softer” and the thicker films hardly “harder”.

The composite glazings produced according to the invention preferably exhibit 2,3 or 4 class Panes with, correspondingly, 1,2 or 3 film laminates produced according to the invention. In addition, the composite glazings may contain single layer standard intermediate layer films.

Preferably, film laminates contain 2 or 3 partial films, in particular those of the combination “hard/soft/hard” or “soft/hard/soft” or “unchanged/soft/unchanged” or “soft/unchanged/soft”.

### Suitability for Commercial Use

Film laminates produced according to the invention have the advantage that partial films with previously adjusted proportions of plasticiser can be produced and stored separately. If film laminates with special properties are required for the manufacture of composite glazings, the corresponding partial films can be combined before the actual glass laminate production as a result of which the migration process of the plasticiser components begins. After adjusting the thermodynamic equilibrium of the plasticiser concentration, the film laminate with the desired properties is obtained. The process according to the invention is substantially simpler to carry out than coextrusion of partial films.

### EXAMPLES

For the determination of the plasticiser migration, the films produced in the conventional manner with the compositions according to table 1 were cut to a size of 30×30 cm, conditioned to a moisture content of between 0.30% by weight and 0.60% by weight and bonded together by their surfaces by being placed between two PET films and float glass and in this stack passing through a process such as it is used for the production of composite safety glass. The process consisted of a roller pre-composite step in which the prelaminate passes through the gap between two rubber-jacketed rollers after having previously been heated to approximately 60° C. Subsequently, the films were melted together in the prebonded panes in a pressure autoclave at 140° C. and 12 bar for 60 minutes. The glasses were stored for 48 h at room temperature in order to allow supersaturated dissolved air to escape from the film layer (PET is permeable to air). Subsequently, the glasses were stored for 48 h at 60° C. in a warming cabinet.

After removing the float glass adhering loosely to the PET film, the PET film was peeled off from the films which were now bonded together The double films bonded together by their surfaces were separated in the middle by means of a peeling device such that it was possible to identify and quantify the plasticisers present for the upper and the underside of the double film by gas chromatography.

TABLE 1
Film combinations

| | |
|---|---|
| | Laminated |
| Individual Film | Films A/B |

| | K 2839 | K 2841 | | |
|---|---|---|---|---|
| Example 1 | (A) | (B) | A | B |
| % PVOH | 18.3 | 23.5 | 18.3 | 23.5 |
| Plasticiser content 1 | C^{A}1 | C^{B}1 | C^{A}1′ | C^{B}1′ |
| % 3G7 (1) | 26 | 26 | 26.7 | 24.2 |
| | K 2839 | K 2842 | | |
| Example 2 | (A) | (B) | A | B |
| % PVOH | 18.3 | 23.5 | 18.3 | 23.5 |
| Plasticiser content 1 | C^{A}1 | C^{B}1 | C^{A}1′ | C^{B}1′ |
| % 3G7 (1) | 26 | 0 | 11.9 | 13.7 |
| Plasticiser content 2 | C^{A}1 | C^{B}1 | C^{A}1′ | C^{B}1′ |
| % 3G8 (2) | 0 | 26 | 16.2 | 9.2 |
| Total plasticiser | 26 | 26 | 28.1 | 22.9 |
| | K 2840 | K 2844 | | |
| Example 3 | (A) | (B) | A | B |
| % PVOH | 18.3 | 20.6 | 18.3 | 20.6 |
| Plasticiser content 1 | C^{A}1 | C^{B}1 | C^{A}1′ | C^{B}1′ |
| % 3G8 (1) | 26 | 26 | 27.0 | 25.0 |
| | K 2840 | K 2842 | | |
| Example 4 | (A) | (B) | A | B |
| % PVOH | 18.3 | 23.5 | 18.3 | 23.5 |
| Plasticiser content 1 | C^{A}1 | C^{B}1 | C^{A}1′ | C^{B}1′ |
| % 3G8 (1) | 26 | 26 | 27.8 | 24.0 |
| | K 2843 | K 2844 | | |
| Example 5 | (A) | (B) | A | B |
| % PVOH | 20.6 | 20.6 | 20.6 | 20.6 |
| Plasticiser content 1 | C^{A}1 | C^{B}1 | C^{A}1′ | C^{B}1′ |
| % 3G7 (1) | 26 | 0 | 15.3 | 11.1 |
| Plasticiser content 2 | C^{A}2 | C^{B}2 | C^{A}2′ | C^{B}2′ |
| Total plasticiser | 26 | 26 | 25.5 | 26.3 |
| | K 2843 | K 2841 | | |
| Example 6 | (A) | (B) | A | B |
| % PVOH | 26.6 | 23.5 | 20.6 | 23.5 |
| Plasticiser content 1 | C^{A}1 | C^{B}1 | C^{A}1′ | C^{B}1′ |
| % 3G7 (1) | 26 | 26 | 26.5 | 24.7 |

Film Laminates with Improved Acoustic Properties

The effectiveness of the invention can be illustrated by way of the example of partial films which develop improved acoustic properties, on contact with each other, as a result of plasticiser migration.

The sound deadening properties of a glazing are usually measured according to EN ISO 140 on panes of a size of 123×148 cm, those glazings providing better properties which are bonded with an immediate layer which attenuates mechanical vibrations and is thus capable of converting mechanical energy which is ultimately aligned as efficiently as possible into non aligned thermal energy. In DE 101 08 315 A1, a process for measuring the fading constant on composite glass is described, attenuation being all the better in the case of this test procedure the lower the value of the fading constant. Correspondingly, a large format pane produced with an intermediate layer material with a low fading constant will have better sound deadening properties in laboratory tests and in practical use than a pane with otherwise the same dimensions with an intermediate layer material with a higher fading constant.

In order to demonstrate the effect of plasticiser migration between different partial films, the following procedure was implemented: in a manner known to the expert, a pair of float class Panes with a thickness of 2 mm was bonded in each case with an intermediate layer composed of partial films with a thickness of 0.76 mm (FIG. 2), the partial films being separated, in each case, for comparison, by a PET film 50 μm thick, causing migration of the film components to be prevented (FIG. 3). In FIGS. 2 and 3, A and B represent the plasticiser-containing PVB films F and F′ for float glass and P for PET film.

The additional PET layer of low thickness has no direct influence on the vibration behaviour of the sample body used for measuring attenuation which was cut out from the finished glass/film/glass laminate as a rod with the dimensions 10×30 cm.

| | | | Fading constant at | |
|---|---|---|---|---|
| | | | 23° C. on the laminate | |
| | | | rod with film | |
| | Individual Film | | laminate: | |
| Example 7 | MB (A) | K 2851 (B) | A/B | A/PET/B |
| % PVOH | 20.5 | 18.3 | 5.19 ms⁻¹ | 5.58 ms⁻¹ |
| Plasticiser | C^{A}1 | C^{B}1 | | |
| content 1 | | | | |
| % 3G7 (1) | 26 | 0 | | |
| Plasticiser | C^{A}2 | C^{B}2 | | |
| content 2 | | | | |
| % DHA (2) | 0 | 20 | | |
| Plasticiser | C^{A}3 | C^{B}3 | | |
| content 3 | | | | |
| % NP6 (3) | 0 | 10 | | |
| Total | 26 | 30 | | |
| Plasticiser | | | | |
| Example 8 | K 2904 (A) | K 2851 (B) | A/B | A/PET/B |
| % PVOH | 23.5 | 18.3 | 0.03 ms⁻¹ | 4.31 ms⁻¹ |
| Plasticiser | C^{A}1 | C^{B}1 | | |
| content 1 | | | | |
| % 4GDME (1) | 26 | 0 | | |
| (1) | | | | |
| Plasticiser | C^{A}2 | C^{B}2 | | |
| content 2 | | | | |
| % DHA (2) | 0 | 20 | | |
| Plasticiser | C^{A}3 | C^{B}3 | | |
| content 3 | | | | |
| % NP6 (3) | 0 | 10 | | |
| Total | 26 | 30 | | |
| Plasticiser | | | | |

NP6: Marlophen ® NP6;
4GDME: tetraethylene glycol dimethyl ether
MB (A): Trosifol MB from Kuraray Specialities Europe GmbH.

In the case of the partial film combination according to example 7, the plasticiser migration leads to an improvement in the fading constant by approximately 7%, in the case of the partial film combination from example 8 to an improvement by approximately 30% compared with the respective comparative example with a PET barrier layer. In both cases, a corresponding improvement in sound deadening can be ascertained also on a large format pane.

For the plasticisers used in the examples, the solubility parameter according to Small can be calculated as follows: DHA 8.65 (cal/cm3)½), 4 GDME 8.41 (cal/cm3)½, 3G7 8.68 (cal/cm3)½ and NP 6 8.77 (cal/cm3)½. In example 7, the maximum difference between the solubility parameter of a pair of plasticisers is consequently 0.12 (cal/cm3)½, in example 8 0.36 (cal/cm3)½. The δ values of the PVB resins in the examples can be found in the table in the description.

The maximum difference between the solubility parameters of the PVB resins used here consequently amounted to 0.11 (cal/cm3)½ in example 7 and 0.19 (cal/cm3)½ in example 8.

Film Laminates with Improved Mechanical Properties

The effectiveness of the invention is illustrated by the example of partial films which, on contact, develop a high mechanical strength as a result of plasticiser migration, i.e. become harder.

From two panes of float glass (Planilux®) of a thickness of 4 mm and different partial films, VSG with a dimension of 90×110 cm was made in the manner known to the expert. This involved a precomposite step in the case of which the initially loosely formed stack of the two class Panes with the partial films present in between, after preheating of the glass stack to a temperature of approximately 60° C. with the application of pressure, is passed through a roller gap, followed by an autoclave process in which the precomposites are bonded to form the final composite with the application of a pressure of 12 bar and heat at 140° C.

The finished VSG were stored initially at a temperature of 23° C. for 24 h and subsequently tested according to EN 356 (1999) for their penetration resistance with respect to class P4A/P5A. The test for class P5A was modified to the extent that, for each individual test pane, the number of balls dropped consecutively from the predetermined dropping height of 9 m was counted. This can amount to maximum 9, each impact site being hit by a ball three times and should be a minimum of 3 in order to pass the test for class P4A. For a better statistical guarantee, 3 composite class Panes were tested for each material.

In order to eliminate the possibility of the result being influenced by different levels of adhesion between the film laminate and glass, the upper and underside of the film laminates used in the example and the reference example consist of one and the same material.

The sequence of the partial films in the film laminate of the comparative example/example consisted of:

### EXAMPLE 9

### Not According to the Invention

| | | |
|---|---|---|
| Partial film A | TROSIFOL ® PG4015 | in a thickness of 0.38 mm |
| Partial film B | TROSIFOL ® VG | in a thickness of 0.76 mm |
| Partial film A | TROSIFOL ® PG4015 | in a thickness of 0.38 mm |

### EXAMPLE 10

### According to the Invention

| | | |
|---|---|---|
| Partial film A | TROSIFOL ® PG4015 | in a thickness of 0.38 mm |
| Partial film B | K 2903 | in a thickness of 0.76 mm |
| Partial film A | TROSIFOL ® PG4015 | in a thickness of 0.38 mm |

The chemical composition of the product TROSIFOL VG and PG (Kuraray Specialities Europe GmbH) is identical with respect to the plasticiser and the PVB resin used: both products are based on PVB resin with a PVOH content of 20.9% by weight and the plasticiser 3G8 in combination with an addition of a non-ionic surfactant which increases the compatibility, as co-plasticiser with identical first Plasticiser contents.

Partial film K 2903 is based on a PVOH resin with a PVOH content of 23.5% by weight and contains the plasticiser 4GDME (tetraethylene glycol dimethyl ether) with a first Plasticiser content of 23% by weight.

Results of the penetration test with respect to class P4A/P5A (number of balls held)

| | Number of balls held | | |
|---|---|---|---|
| | VSG 1 | VSG 2 | VSG 3 |
| Example 9 | 3 | 3 | 4 |
| Example 10 | 6 | 9 | 6 |

The intermediate film according to the invention from example 10 consequently withstands approximately twice the number of impacts from a steel ball weighing 4.11 kg than a standard film and consequently exhibits a substantially improved protection level with the same overall thickness of the film layer.

1. A process for producing film laminates comprising:
laminating at least two partial films, at least one of said partial films containing at least one plasticizer with a first plasticiser content,
wherein migration of said at least one plasticiser occurs between said at least two partial films resulting in adjustment of the plasticizer content of said at least one partial film to a second plasticiser content,
wherein said first and second plasticiser contents of said at least one of said partial films differ by at least 0.5% by weight and said partial films are based on different polymers.

2. A process according to claim 1, wherein said partial films possess a different first plasticiser contents.

3. A process according to claim 1, wherein said partial films contains different plasticisers or plasticiser mixtures of different composition.

4. A process according to claim 1, wherein at least one partial film is based on acetalised polyvinyl alcohol and the film laminate contains at least two plasticisers whose solubility parameters δ differ by at least 0.01 (cal/cm³)^{1/2}.

5. A process according to claim 1, wherein said film laminate contains at least two partial films based on acetalised polyvinyl alcohol, whose solubility parameters δ differ by at least 0.001 (cal/cm³)^{1/2}.

6. A process according to claim 1, wherein the migration of the plasticisers between the partial films takes place by an at least 30 min storage of the film laminates at minimum 40° C.

7. A process according to claim 1, wherein said partial films are each based on entirely or partially acetalised polyvinyl alcohol, polyvinyl butyral, polyvinyl chloride, ethylene-vinyl acetate copolymer, ethylene-vinyl alcohol copolymer and/or entirely or partially acetalised ethylene-vinyl alcohol copolymer.

8. A process according to claim 1, wherein partial films which contain entirely or partially acetalised polyvinyl alcohol with different polyvinyl alcohol content and/or residual acetate content are laminated to each other.

9. A process according to claim 1, wherein said partial films are based on entirely or partially acetalised polyvinyl alcohol with a residual acetate content of 0 to 3.5 mole %.

10. A process for producing composite systems from at least two rigid bodies and at least one film laminate, said process comprising:
laminating at least two partial films, at least one of said partial films containing at least one plasticiser with a first plasticiser content, wherein migration of said at least one plasticiser occurs between at least two partial films resulting in adjustment of the plasticizer content of said at least one partial film to a second plasticiser content, wherein said first and second plasticiser contents of said at least one of said partial films differ by at least 0.5% by weight and said partial films are based on different polymers,
arranging said partial films between said rigid bodies and applying an elevated temperature and an increased or reduced pressure.
